(19) United States
(12) Patent Application Publication
(10) Pub. No.: US 2022/0126585 A1
(43) Pub. Date: Apr. 28, 2022

(54) PRINTING DEVICE

(71) Applicant: BROTHER KOGYO KABUSHIKI KAISHA, Nagoya (JP)

(72) Inventor: Shunsuke OKAI, Nagoya (JP)

(21) Appl. No.: 17/512,215

(22) Filed: Oct. 27, 2021

(30) Foreign Application Priority Data
Oct. 27, 2020 (JP) 2020-179989
Oct. 12, 2021 (JP) 2021-167231

(51) Int. Cl. B41J 2/165; B41J 2/21

(52) U.S. Cl. CPC B41J 2/16517; B41J 2/21

(57) ABSTRACT

A printing device includes an inkjet head, an accommodating portion configured to accommodate a filter that collects ink mist, and a guide portion arranged above the accommodating portion and configured to guide waste ink droplets due to the ink mist to the filter accommodated in the accommodating portion. In the printing device, the guide portion has a shape in which the waste ink droplets drop onto the filter.

### CROSS-REFERENCE TO RELATED APPLICATION

This application claims priorities from Japanese Patent Applications Nos. 2020-179989 filed on Oct. 27, 2020, and 2021-167231 filed on Oct. 12, 2021, the contents of which are incorporated herein by reference in its entirety.

### BACKGROUND ART

The present disclosure relates to a printing device.

An inkjet type printing device in the related art includes a head, a carriage, a printing area, a maintenance and recovery mechanism, and an absorbing member. The head is mounted on the carriage, moves in a main scanning direction, and prints on a recording medium including paper conveyed to the printing area. The maintenance and recovery mechanism is provided on a main scanning direction side from the printing area, and performs maintenance and recovery of the head. A space is provided between the printing area and the maintenance and recovery mechanism. The absorbing member that absorbs ink mist is provided at a bottom portion of the space.

### SUMMARY

In the related-art printing device, waste ink droplets formed of the ink mist flow along a wall surface extending upward from the bottom portion where the absorbing member is provided. As a result, waste ink may contaminate the wall surface forming the space in which the absorbing member is provided.

An object of the present disclosure is to provide a printing device capable of reducing a possibility that a filter accommodating portion is contaminated.

A printing device according to an aspect of the present disclosure includes: an inkjet head; an accommodating portion configured to accommodate a filter that collects ink mist; and a guide portion arranged above the accommodating portion and configured to guide waste ink droplets due to the ink mist to the filter accommodated in the accommodating portion. The guide portion guides the waste ink droplets formed of the ink mist to the filter, and the filter collects the waste ink droplets. Therefore, a possibility that the accommodating portion is contaminated by the waste ink droplets is reduced as compared with the printing device in which the guide portion is not provided.

### BRIEF DESCRIPTION OF THE DRAWINGS

FIG. 1 is a perspective view of a part of a printing device 1.

FIG. 2A is a plan view showing an internal structure of the printing device 1.

FIG. 2B is an enlarged view of a cleaning mechanism 503.

FIG. 3 is a bottom view of heads 31 to 36 showing nozzle rows 301 to 303.

FIG. 4A is a front view showing the internal structure of the printing device 1.

FIGS. 4B and 4C are enlarged view of mist collection mechanisms 73 and 74.

FIGS. 5A and 5B are front views showing opening and closing between a use position P2 and a replacement position P1 of an accommodating portion 49 of the mist collection mechanism 73.

FIGS. 6A and 6B are plan views showing opening and closing between the use position P2 and the replacement position P1 of the accommodating portion 49 of the mist collection mechanism 73.

FIG. 7 is a perspective view showing an open state of the accommodating portion 49.

FIG. 8 is a perspective view of the mist collection mechanism 73 in which a filter unit 48 is accommodated in the accommodating portion 49.

FIGS. 9A and 9B are perspective views showing a shape of the filter unit 48.

FIG. 10 is a plan view of a state in which the filter unit 48 is accommodated at the accommodating position P3 of the accommodating portion 49.

FIG. 11A is a side view showing a state in which the filter unit 48 abuts on a second positioning portion 202 of the accommodating portion 49.

FIG. 11B is a side view showing a state in which the filter unit 48 is guided by the second positioning portion 202 of the accommodating portion 49.

FIG. 12 is a cross-sectional view of the printing device 1 showing partition plates 28, 29, in which a first maintenance mechanism 4 and a second maintenance mechanism 5 are not shown.

FIG. 13 is a block diagram showing an electrical configuration of the printing device 1.

FIG. 14 is an explanatory view of a flow of air inside the printing device 1 when fans 94, 95, 862, 863 are driven.

### DETAILED DESCRIPTION

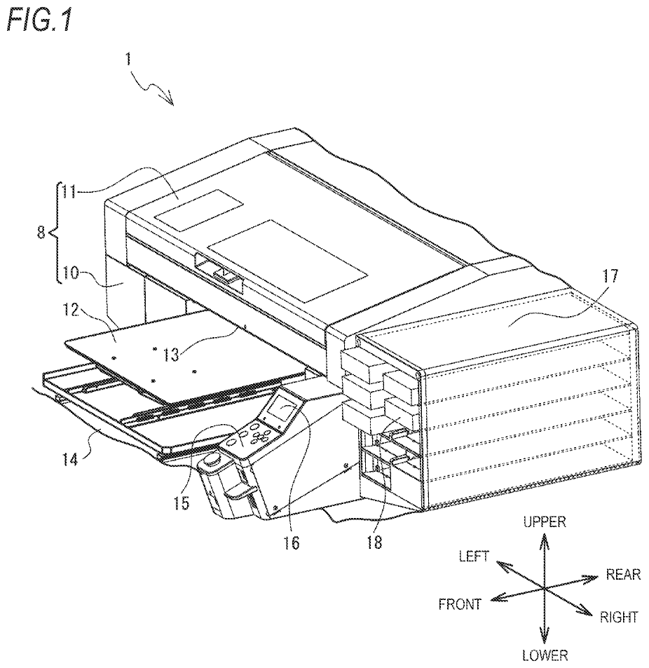

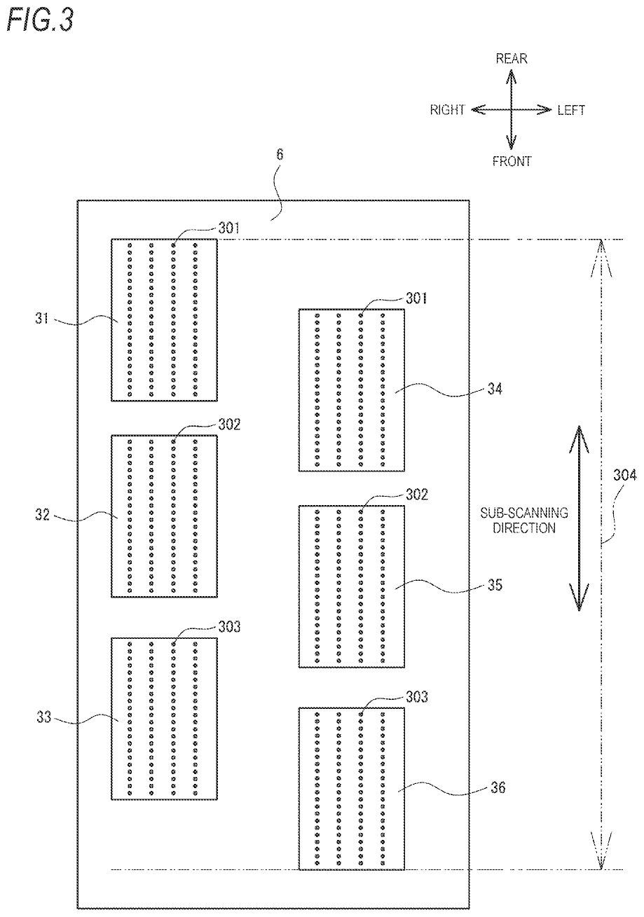

A printing device 1 according to an embodiment of the present disclosure will be described with reference to the drawings. An upper side, a lower side, a lower left side, an upper right side, a lower right side and an upper left side in FIG. 1 respectively correspond to an upper side, a lower side, a front side, a rear side, a right side and a left side of the printing device 1. An upper-lower direction in FIG. 1 is a vertical direction. In the following description, a left-right direction may be referred to as a main scanning direction, and a front-rear direction may be referred to as a sub-scanning direction. In the present embodiment, mechanical elements in the drawings other than those in FIG. 3 indicate actual relations in dimension.

The printing device 1 shown in FIG. 1 is an inkjet printer, and prints by ejecting ink onto a printing medium including cloth or paper. The printing device 1 can print a color image on the printing medium using white ink and color ink (ink in four colors of black, yellow, cyan and magenta).

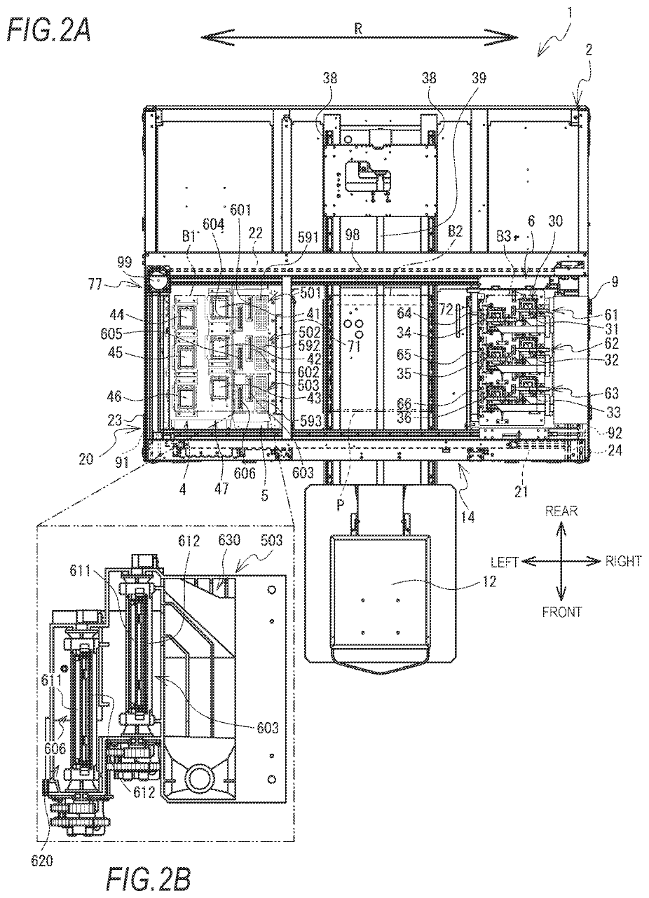

An external configuration of the printing device 1 will be described with reference to FIGS. 1, 2A and 2B. As shown in FIG. 1, the printing device 1 includes a housing 8, a conveyance mechanism 14, an operation button 15, a display screen 16 and a storage unit 17. The housing 8 has a rectangular parallelepiped shape, and includes a main body 10 and a lid 11. In the main body 10, a platen opening 13 having a rectangular shape in a front view is formed at a center of a sub-scanning direction side of the housing 8, that is, the platen opening 13 is formed on a front surface of the housing 8 at a center in the left-right direction. In the present embodiment, the sub-scanning direction is the front-rear direction. An internal position P described later is located behind the platen opening 13. The lid 11 is provided on an upper side of the main body 10 and can be opened and closed between a position where an upper surface of the main body 10 is covered and a position where the upper surface of the main body 10 is opened by rotating about a rear end of the lid 11. Hereinafter, a space surrounded by the upper surface, a right surface, a bottom surface and a left surface of the housing 8 is referred to as inside of the housing 8.

The operation button 15 and the display screen 16 are provided on a right side of the platen opening 13 on the front surface of the housing 8. The operation button 15 inputs various types of information to the printing device 1 according to an operation by an operator. The display screen 16 displays the various types of information. Therefore, the operator operates the printing device 1 on a front side of the printing device 1.

The conveyance mechanism 14 conveys a platen 12, on which the printing medium is arranged, between the internal position P of the housing 8 and outside of the housing 8 through the platen opening 13. The platen 12 is arranged at the internal position P of the housing 8 shown in FIG. 2A, and a liquid is ejected from a head 30 described later to perform printing.

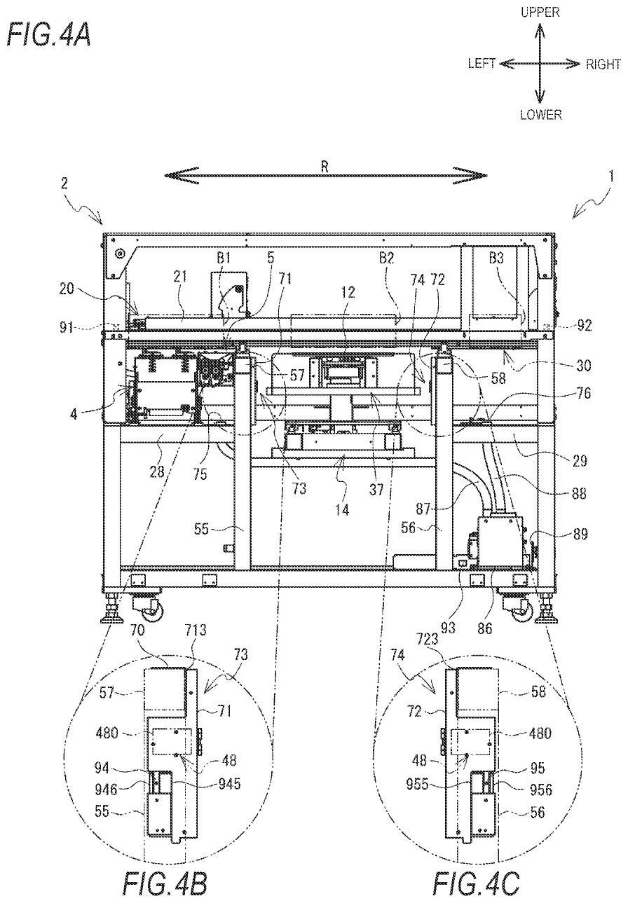

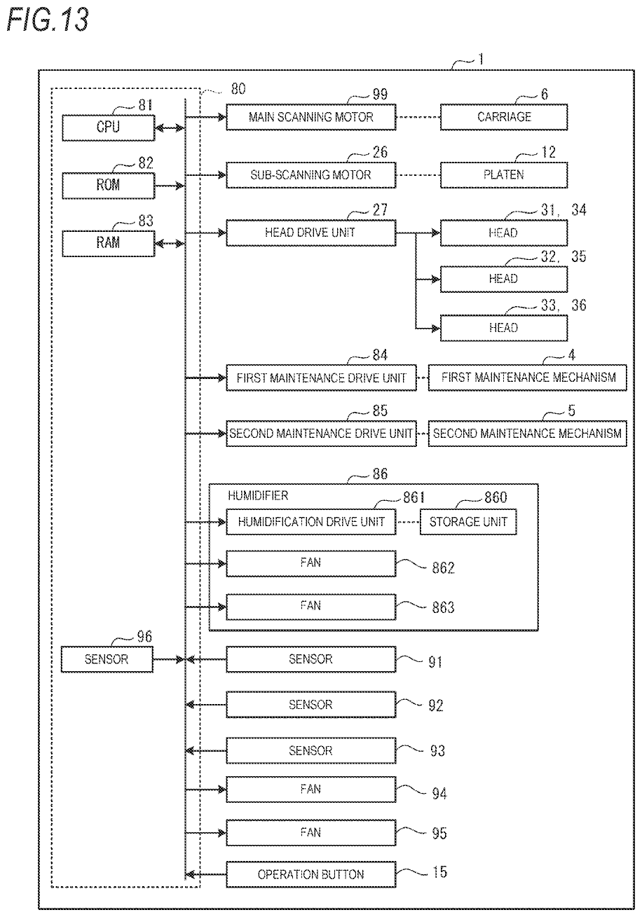

As shown in FIG. 2A, the conveyance mechanism 14 includes a platen support portion 37 (see FIG. 4A), a pair of left and right rails 38, a transmission member 39 and a sub-scanning motor 26 (see FIG. 13). The platen support portion 37 supports the platen 12 from below. The platen 12 has a plate shape. The pair of left and right rails 38 extend in the front-rear direction and support the platen support portion 37 so as to be movable in the front-rear direction. Front ends of the pair of rails 38 are located forward than the front surface of the housing 8.

The transmission member 39 is connected to the platen support portion 37 and the sub-scanning motor 26, and moves the platen support portion 37 in the front-rear direction along a conveyance path defined by the pair of left and right rails 38 in response to driving of the sub-scanning motor 26.

In a state where the platen 12 is arranged in front of the front surface of the housing 8, that is, outside the housing 8, the operator arranges the printing medium on an upper surface of the platen 12. As shown in FIG. 2A, the storage unit 17 is provided on a right side of the housing 8. A plurality of cartridges 18 are stored in the storage unit 17 from a front side. The cartridges 18 contain various types of liquid including ink used for printing.

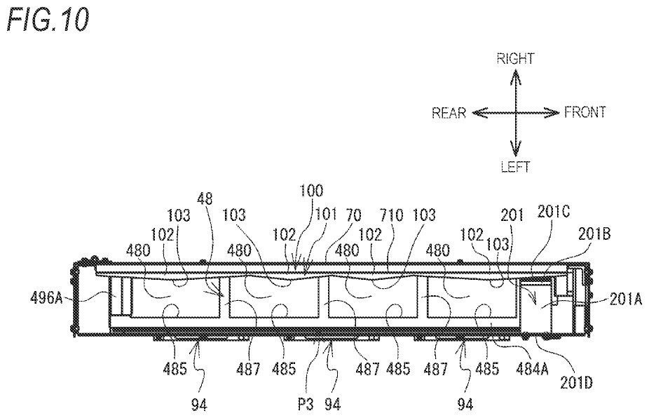

An internal structure of the printing device 1 will be described with reference to FIGS. 2A to 12. As shown in FIG. 2A, the printing device 1 includes, inside the housing 8 shown in FIG. 1, a frame body 2, inner walls 71, 72 (see FIG. 4A), partition plates 28, 29 (see FIG. 4A), a carriage 6, heads 31 to 36, a substrate box 9, a movement mechanism 77, a first maintenance mechanism 4, a second maintenance mechanism 5, mist collection mechanisms 73, 74 (see FIG. 4A), a humidifier 86 (see FIG. 4A), and sensors 91 to 93 (see FIG. 4A).

As shown in FIG. 4A, the frame body 2 includes a plurality of shafts including shafts 57, 58 and extending in the front-rear direction, a plurality of shafts extending in the left-right direction, and a plurality of shafts including shafts 55, 56 and extending in the upper-lower direction. A guide shaft 20 is fixed to an upper end of the frame body 2. As shown in FIG. 2A, the guide shaft 20 includes a front shaft 21, a rear shaft 22, a left shaft 23 and a right shaft 24.

The front shaft 21 is arranged at a front end portion of the frame body 2, and extends in the left-right direction from a left end portion to a right end portion of the frame body 2. The rear shaft 22 is arranged substantially at a center of the frame body 2 in the front-rear direction, and extends in the left-right direction from the left end portion to the right end portion of the frame body 2. The left shaft 23 is arranged at the left end portion of the frame body 2, and extends in the front-rear direction from a left end of the front shaft 21 to a left end of the rear shaft 22. The right shaft 24 is arranged at the right end portion of the frame body 2, and extends in the front-rear direction from a right end of the front shaft 21 to a right end of the rear shaft 22. The front shaft 21 and the rear shaft 22 support the carriage 6. The conveyance mechanism 14 is fixed to the frame body 2.

As shown in FIG. 4A, the inner walls 71, 72 are arranged to face each other in the main scanning direction intersecting the sub-scanning direction at the internal position P of the housing 8. The inner walls 71, 72 extend in the front-rear direction below the guide shaft 20 and are fixed to the frame body 2. The inner wall 71 is provided on a left side of the platen 12 arranged at the internal position P, and is fixed to the shaft 57. The inner wall 72 is provided on a right side of the platen 12 arranged at the internal position P, and is fixed to the shaft 58. The inner walls 71, 72 are located between the front shaft 21 and the rear shaft 22 in the front-rear direction.

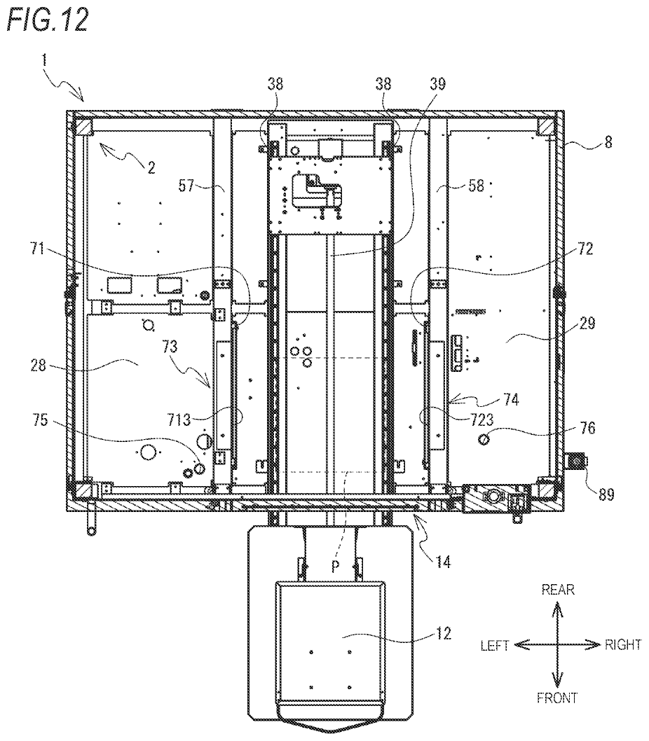

The partition plate 28 is fixed to the frame body 2 below the guide shaft 20 and on a left side of the inner wall 71, and extends in the front-rear and left-right directions. A right end portion of the partition plate 28 is connected to a lower end portion of the inner wall 71. The partition plate 29 is fixed to the frame body 2 below the guide shaft 20 and on a right side of the inner wall 72, and extends in the front-rear and left-right directions. A left end portion of the partition plate 29 is connected to a lower end portion of the inner wall 72. As shown in FIG. 12, a supply port 75, which has a circular shape in a plan view and penetrates the partition plate 28 in the upper-lower direction, is formed in a right front portion of the partition plate 28. A supply port 76, which has a circular shape in a plan view and penetrates the partition plate 29 in the upper-lower direction, is formed in a left front portion of the partition plate 29. A positional relationship between the supply port 75 and the supply port 76 is not particularly limited, but in the present embodiment, the supply port 75 is formed in front of the supply port 76 in the front-rear direction.

As shown in FIG. 2A, the carriage 6 is supported by the front shaft 21 and the rear shaft 22 so as to be movable in the main scanning direction. The carriage 6 is provided with mounting portions 61 to 66. The heads 31 to 36 are mounted on the mounting portions 61 to 66, respectively. The mounting portions 61, 62, 63 are arranged at a right portion of the carriage 6, and are arranged in a row from a rear side to a front side in an order of the mounting portions 61, 62, 63. The mounting portions 64, 65, 66 are arranged on a left side of the row of the mounting portions 61, 62, 63, and are arranged in a row from a rear side to a front side in an order of the mounting portions 64, 65, 66.

Each of the heads 31 to 36 is arranged inside the housing 8 and ejects a liquid. FIG. 3 is a bottom view of the heads 31 to 36. As shown in FIG. 3, each of the heads 31, 34 includes a nozzle row 301 having nozzles that eject the white ink. Each of the heads 32, 35 includes a nozzle row 302 that is arranged in the sub-scanning direction with respect to the nozzle row 301 and has nozzles that eject an auxiliary liquid including a pretreatment agent or a discharge printing agent. The pretreatment agent is a base coat agent applied before ink is applied to a fabric. The pretreatment agent is a liquid for forming a film between fibers of the fabric such that the ink remains on the fabric more, and is, for example, an aqueous solution containing a resin component and a metal salt including CaCl₂). Each of the heads 33, 36 includes a nozzle row 303 that is arranged in the sub-scanning direction with respect to the nozzle row 301 and has nozzles that ejects the color ink. The nozzle rows 301 to 303 are actually arranged densely in a larger array than that shown in FIG. 3. As shown in FIG. 3, a region from a rear end of the nozzle row 301 of the head 31 to a front end of the nozzle row 303 of the head 36 in the sub-scanning direction is an arrangement region 304 of the nozzle rows 301 to 303. A liquid including the white ink, the color ink and the auxiliary liquid may be ejected from any one of the heads 31 to 36. In the present embodiment, the white ink is supplied to each of the heads 31, 34 from the white ink cartridge 18. The discharge printing agent is supplied to each of the heads 32, 35 from the discharge printing agent cartridge 18. The discharge printing agent is a liquid for discharging a color of the printing medium. The color ink is supplied to each of the heads 33, 36 from the color ink cartridge 18. Each of the heads 31 to 36 ejects the ink or the auxiliary liquid downward when the heads 31 to 36 are at a printing position B2 described later. Hereinafter, when the heads 31 to 36 are collectively referred to, or when any of the heads 31 to 36 is not specified, the heads 31 to 36 are referred to as the head 30.

The movement mechanism 77 moves the carriage 6, on which the head 30 is mounted, in the main scanning direction. The movement mechanism 77 includes a drive belt 98 and a main scanning motor 99. The drive belt 98 is connected to a rear end portion of the carriage 6. The drive belt 98 is provided on the rear shaft 22 and extends in the left-right direction. A left end portion of the drive belt 98 is connected to the main scanning motor 99. When the main scanning motor 99 is driven, the drive belt 98 moves the carriage 6 in the left-right direction along the front shaft 21 and the rear shaft 22.

In FIGS. 2A and 4A, a movement range R of the head 30 is indicated by using a center of the carriage 6 in the left-right direction. As shown in FIG. 3, the head 30 is mainly arranged at one of three positions including a maintenance position B1, the printing position B2 and a head standby position B3, by the movement mechanism 77. The maintenance position B1 is located at a left end portion of the movement range R of the head 30, and is a position where the head 30 is maintained by the first maintenance mechanism 4 or the second maintenance mechanism 5 described later. The printing device 1 moves the head 30 to the maintenance position B1 when printing is not performed, and performs maintenance by the first maintenance mechanism 4 or the second maintenance mechanism 5. The second maintenance mechanism 5 is located on a right side of the first maintenance mechanism 4. The printing position B2 is a position between the maintenance position B1 and the head standby position B3 in the main scanning direction and above the platen 12 arranged at the internal position P. When the head 30 is arranged at the printing position B2, the head 30 ejects the liquid according to print data, and printing is performed on the printing medium placed on the platen 12. The head standby position B3 is located at a right end position of the movement range R of the head 30, and is a position where the head 30 is arranged when the operator performs an operation including cleaning on the head 30. For example, the printing device 1 moves the head 30 to the head standby position B3 and causes the head 30 to stand by according to an instruction based on the operation button 15 when printing is not performed.

The first maintenance mechanism 4 is provided at a position facing the head 30 arranged at the maintenance position B1 to maintain the head 30. The first maintenance mechanism 4 is provided on the partition plate 28 on the left side of the inner wall 71 in the housing 8 and below the guide shaft 20. As shown in FIG. 2A, the first maintenance mechanism 4 includes six caps 41 to 46 and a cap support portion 47. A sponge containing a moisturizing liquid is arranged inside each of the caps 41 to 46. A positional relationship of the caps 41 to 46 is the same as a positional relationship of the mounting portions 61 to 66. Each of the caps 41 to 46 has a rectangular shape in a plan view, and is supported from below by the cap support portion 47. The cap support portion 47 moves the caps 41 to 46 in the upper-lower direction. When printing is not performed, the printing device 1 moves the cap support portion 47 upward in a state where the head 30 is located at the maintenance position B1. Thereby, the caps 41 to 46 cover and cap nozzle surfaces of the heads 31 to 36 from below. As a result, drying of the ink or the discharge printing agent in a nozzle provided on the nozzle surface of the head 30 is prevented.

The second maintenance mechanism 5 is provided at a position facing the head 30 arranged at the maintenance position B1 to maintain the head 30. As shown in FIG. 4A, the second maintenance mechanism 5 is provided on the partition plate 28 on the left side of the inner wall 71 in the housing 8 and below the guide shaft 20. The second maintenance mechanism 5 is located between the first maintenance mechanism 4 and the inner wall 71 in the main scanning direction. The second maintenance mechanism 5 is a mechanism that cleans the head 30 by performing wiping and flushing operations on the nozzle surface of the head 30.

As shown in FIG. 2A, the second maintenance mechanism 5 includes cleaning mechanisms 501 to 503. The cleaning mechanisms 501 to 503 are located on a right side of the caps 41 to 43, respectively. The cleaning mechanisms 501 to 503 have the same structure. The cleaning mechanism 501 includes wipers 601, 604 and a punching metal 591. The cleaning mechanism 502 includes wipers 602, 605 and a punching metal 592. The cleaning mechanism 503 includes a wiper 603 and a wiper 606. Each of the cleaning mechanisms 501 to 503 further includes a cleaning liquid tank 620 and a flushing box 630. In an enlarged view of the cleaning mechanism 503 in FIG. 2B, the punching metal 593 is not shown.

The wipers 601 to 606 wipe the nozzle surfaces of the heads 31 to 36, respectively. Each of the wipers 601 to 606 includes a foam wiper 611 and a rubber wiper 612. The foam wiper 611 is configured to be vertically reversed by a vertical reversing mechanism (not shown) or the like, and to be capable of entering the cleaning liquid tank 620. Therefore, the foam wiper 611 is moistened by a cleaning liquid. The flushing box 630 is provided below each of the punching metals 591 to 593, and receives the liquid that is ejected from the head 30 by the flushing operation and passes through each of the punching metals 591 to 593.

The mist collection mechanisms 73, 74 collect mist generated when the liquid is ejected from the head 30. As shown in FIG. 4A, in the main scanning direction, the mist collection mechanism 73 is provided on a left side of the conveyance mechanism 14 inside the housing 8 (see FIG. 1), and the mist collection mechanism 74 is provided on a right side of the conveyance mechanism 14 inside the housing 8. Since the mist collection mechanisms 73, 74 have configurations bilaterally symmetrical to each other as shown in FIGS. 4B and 4C, the configuration of the mist collection mechanism 73 will be described below, and description of the mist collection mechanism 74 will be omitted.

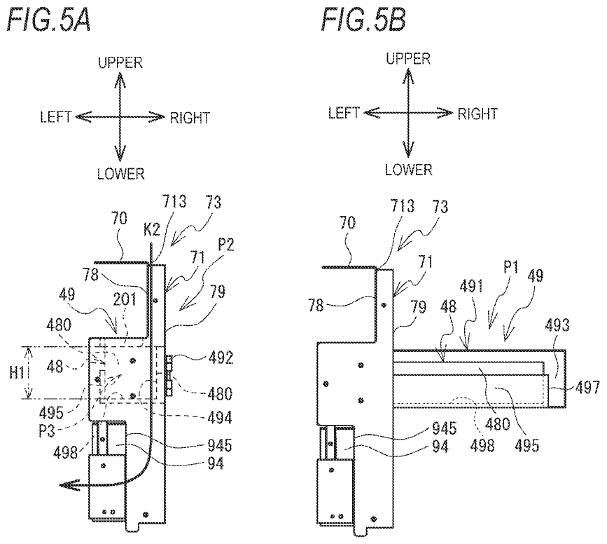

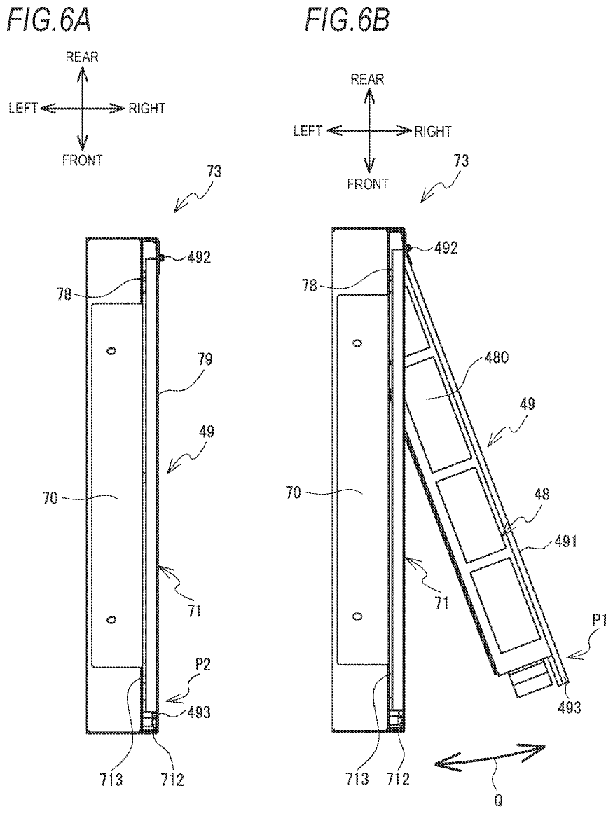

As shown in FIGS. 5A to 8, the mist collection mechanism 73 includes the inner wall 71, three fans 94 (see FIGS. 6A and 6B) and a filter unit 48. The inner wall 71 has a hollow box shape. A right surface 79 of the inner wall 71 has a plate shape extending in the upper-lower and front-rear directions. A slit-shaped suction port 713 elongated in the front-rear direction is formed in an upper surface of the inner wall 71.

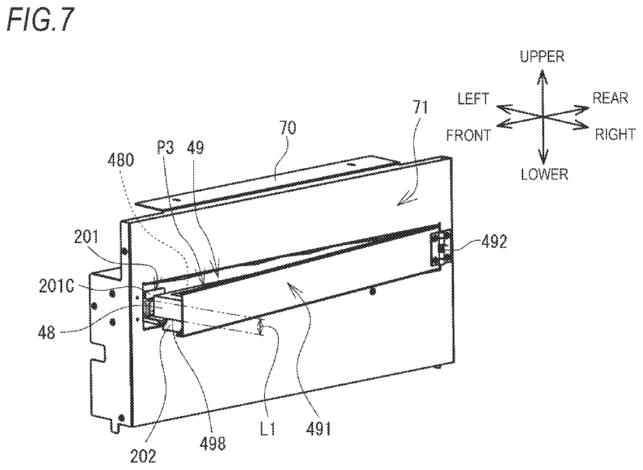

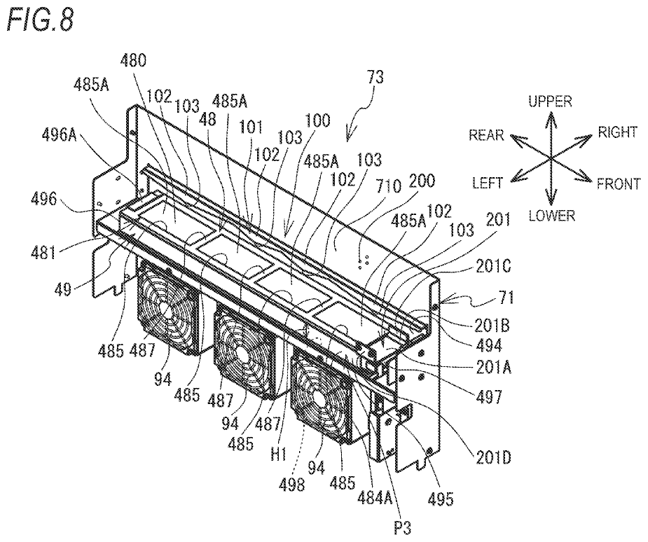

As shown in FIG. 7, the inner wall 71 includes a fixing plate 70 and an accommodating portion 49. The fixing plate 70 is a plate-shaped portion extending in the left-right direction at an upper end of the inner wall 71. As shown in FIG. 4B, the fixing plate 70 is fixed to the shaft 57 extending in the front-rear direction. As shown in FIG. 8, the accommodating portion 49 accommodates the filter unit 48 having a built-in filter 480. FIG. 8 shows a state in which the fixing plate 70 is removed. The accommodating portion 49 has a box shape, and detachably accommodates the filter unit 48 having a rectangular parallelepiped shape elongated in the front-rear direction inside the inner wall 71. The accommodating portion 49 is provided so as to be openable and closable with respect to the right surface 79 of the inner wall 71 in a direction indicated by an arrow Q (see FIG. 6B) by a hinge 492 connected to a rear end portion of the right surface of the inner wall 71 and a rear end portion of a right surface of a main body 491 of the accommodating portion 49. An engaging portion 493 is provided at a right front portion of the accommodating portion 49, and engages with an engaged portion 712 provided at a front end portion of the right surface 79 of the inner wall 71 so as not to be opened and closed without an operation of the operator.

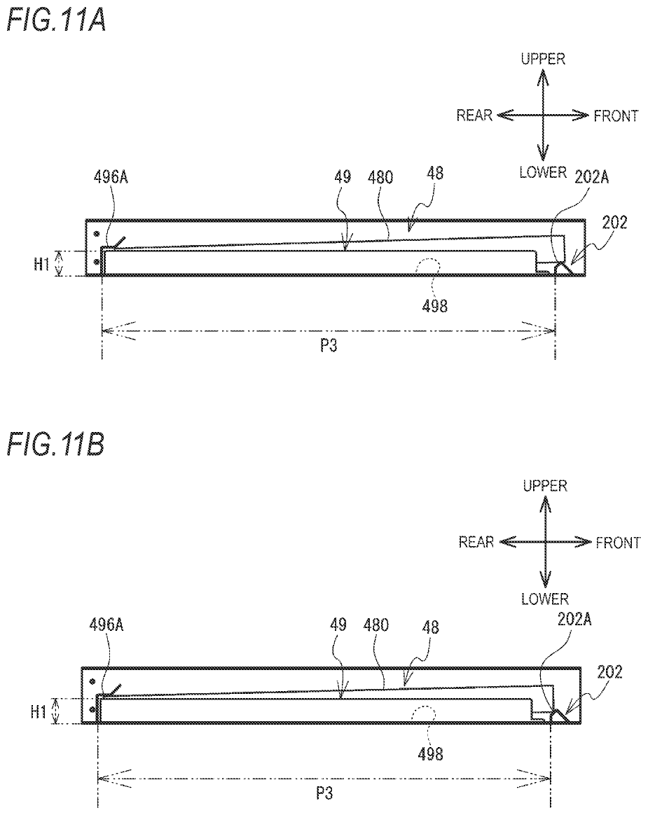

A structure of the accommodating portion 49 will be described with reference to FIG. 8. As shown in FIG. 8, the accommodating portion 49 has a box shape whose upper side is open, and extends in the front-rear direction. The accommodating portion 49 includes a side wall 495, a rear wall 496, a front wall 497 and a side wall 494 along the inner wall 71 (see FIG. 5A). A side wall (not shown) extends in the front-rear direction at a predetermined height along the fixing plate 70 shown in FIG. 7. The height of the side wall (not shown) is, for example, slightly higher than a height of the filter unit 48. The side wall 495 faces and is parallel to the side wall (not shown), and extends in the front-rear direction at a predetermined height. The height of the side wall 495 is, for example, slightly lower than the height of the filter unit 48. The rear wall 496 is provided on a rear end side of the accommodating portion 49, and extends in the left-right direction at a predetermined height. A locking plate 496A is provided on the rear wall 496. The locking plate 496A extends obliquely upward toward the front. The locking plate 496A locks a rear end portion of an upper surface 484A of the filter unit 48 when the rear end portion of the upper surface 484A is raised. The locking plate 496A is formed of, for example, a metal plate. The accommodating portion 49 includes a bottom surface 498 (see FIGS. 11A and 11B). The bottom surface 498 is a bottom plate extending in the front-rear direction, and includes a plurality of openings (not shown). As shown in FIG. 8, the accommodating portion 49 includes a side wall 710 having a predetermined height extending in the front-rear direction and upward. In the present embodiment, the filter unit 48 can be attached to and detached from the accommodating portion 49 from the front side of the printing device 1.

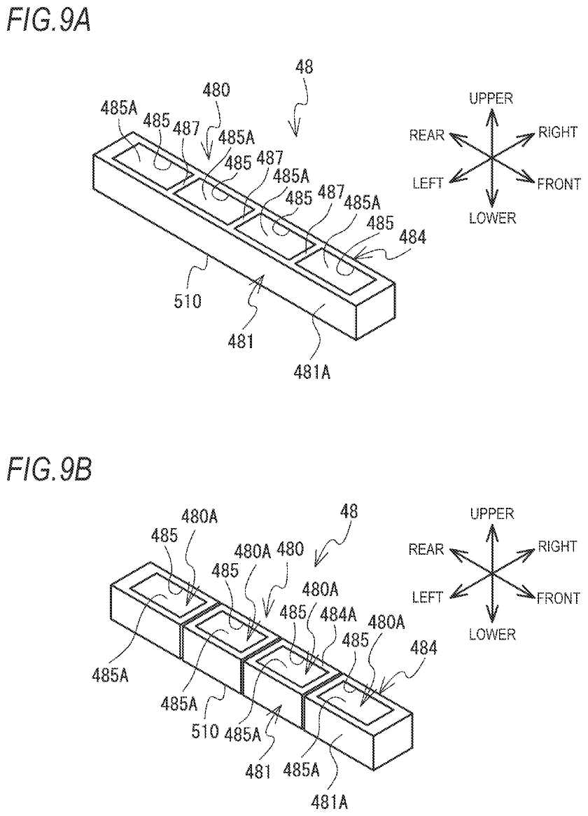

Structures of the filter unit 48 and the filter 480 will be described with reference to FIG. 9A. The filter unit 48 includes the filter 480 and the filter case 481. The filter case 481 is a frame body and supports the filter 480 therein. The filter case 481 has a rectangular parallelepiped shape extending in one direction (forward direction) from one end (rear end) to the other end (front end), and includes an upper case 484 and a lower case 510. The upper case 484 is accommodated above the accommodating portion 49, and the lower case 510 is accommodated below the accommodating portion 49. As shown in FIG. 9A, the upper case 484 includes the rectangular upper surface 484A extending in the front-rear direction. The upper case 484 includes opening edge portions 485 and extension portions 487. The opening edge portion 485 is a rectangular edge portion elongated in the front-rear direction, and forms an opening 485A. The opening edge portion 485 is one edge portion to which the extension portion 487 described later is connected. The extension portion 487 extends in the left-right direction, and both ends of the extension portion 487 are connected to the opening edge portion 485. The extension portions 487 are provided, for example, at three equal intervals of the opening edge portions 485 in the front-rear direction, and have a predetermined width in the front-rear direction. The lower case 510 includes a rectangular bottom surface extending in the front-rear direction (not shown). An opening (not shown) is also provided in the bottom surface of the lower case 510.

The filter 480 adsorbs and collects the mist in the air. The filter 480 is, for example, a resin filter in which a plurality of minute holes are formed, and the mist is adsorbed on a surface of the filter 480. The filter 480 is formed by, for example, overlapping two layers of filters made of the same material. The filter 480 has a rectangular parallelepiped shape extending in the one direction (front-rear direction) from one end (rear end) to the other end (front end). In general, since a filter having only small holes has high mist collection performance, the holes are more likely to be clogged with the mist and the collection performance decreases in a relatively short time, compared to a filter having large holes. In contrast, in the filter 480, it is desirable that an average size of minute holes of the filter 480 becomes smaller toward a downstream side of a flow of the air taken into the inner wall 71 from the suction port 713 by driving of the fan 94. Thereby, a time for which collection performance of the filter 480 decreases is prolonged while increasing a collection rate of the mist by the filter 480.

The three fans 94 shown in FIG. 8 are arranged inside the housing 8 (see FIG. 1). The three fans 94 are arranged at a liquid ejection direction side (that is, downward) from the head 30. For example, the fan 94 may be arranged below the front shaft 21 and the rear shaft 22. The three fans 94 are provided at a lower portion of a left surface 78 of the inner wall 71. The three fans 94 are arranged at substantially equal intervals in the front-rear direction, and have the following configuration. As shown in FIG. 4B, a suction port 945 of the fan 94 is located on a right side of the fan 94, and an exhaust port 946 of the fan 94 is located on a left side of the fan 94. That is, the suction port 945 is located on a side of the platen 12 arranged at the internal position P from the fan 94, and the exhaust port 946 is located on a left surface side of the housing 8 and on a side of the first maintenance mechanism 4 and the second maintenance mechanism 5 from the fan 94. Therefore, the exhaust port 946 of the fan 94 is located inside the housing 8. The fan 94 is arranged between the inner wall 71 and the supply port 75 in the main scanning direction. The suction port 945 of the fan 94 is connected to the lower portion of the left surface 78 of the inner wall 71.

The filter 480 is arranged on a side of the fan 94 from the supply port 75. For example, the filter 480 may be located in a path in the housing 8 from the exhaust port 946 of the fan 94 toward the supply port 75, and more preferably, the filter 480 is arranged in a path in the housing 8 from the head 30 toward the suction port 945 of the fan 94.

The suction port 713 is closer to a mist generation source, that is, the head 30 at the printing position B2 than the suction port 945 of the fan 94. As shown in FIG. 5A, in the mist collection mechanism 73, when each fan 94 is driven, the air sucked into the inner wall 71 from the suction port 713 of the inner wall 71 passes through the filter unit 48, so that the filter 480 adsorbs and collects the mist in the air. The air that has passed through the filter 480 and from which the mist has been collected is discharged from a space inside the inner wall 71 from the suction port 945 of the fan 94 via the exhaust port 946. That is, when the fan 94 is driven, the air flows in a space surrounded by the right surface 79 and the left surface 78 of the inner wall 71 as indicated by an arrow K2.

As shown in FIG. 8, the printing device 1 includes a guide portion 100 arranged above the accommodating portion 49 that accommodates the filter unit 48. The guide portion 100 guides waste ink droplets 200 due to ink mist to the filter 480 accommodated in the accommodating portion 49. The waste ink droplets 200 may adhere to the side wall 710. The guide portion 100 has a shape in which the waste ink droplets 200 drop onto the filter 480. Details of the shape will be described. The guide portion 100 includes a guide plate 101 extending leftward from the side wall 710 arranged above the accommodating portion 49. The guide plate 101 is fixed to the side wall 710 above the accommodating portion 49, and extends longer than the accommodating portion 49 in the front-rear direction. The guide plate 101 is inclined obliquely downward to the left from a fixed position to the side wall 710 at a predetermined angle with respect to a gravity direction. The predetermined angle is, for example, 45 degrees. When the filter case 481 has four openings 485A, which open upward, arranged in the front-rear direction, and the filter 480 is exposed upward at four positions, the guide plate 101 includes four inclined portions 102 in the front-rear direction. Each of the inclined portions 102 has the same shape, and is an isosceles triangle in a plan view. A base of the isosceles triangle is parallel to the side wall 710, and a tip end 103, which is an apex of the isosceles triangle, protrudes obliquely downward to the left. Therefore, the tip end 103 is the lowermost end of the guide plate 101.

As shown in FIG. 8, the filter 480 accommodated in the accommodating portion 49 is arranged at a position lowered in the gravity direction from the tip end 103 of the guide plate 101 on a left side. It is desirable that the tip end 103 of each guide plate 101 faces in the upper-lower direction a center of the opening 485A of the filter case 481 in the front-rear direction. Therefore, the waste ink droplets 200 that have adhered to the side wall 710 flow to the inclined portion 102 of each guide plate 101 due to gravity. Since the inclined portion 102 is inclined obliquely downward to the left and the tip end 103 is the lowermost end, the waste ink droplets 200 are guided by the inclined portion 102 and drop from the tip end 103 to the filter 480.

The accommodating portion 49 shown in FIG. 8 is placed in a lower portion of the arrangement region 304 of the nozzle rows 301 to 303 in the sub-scanning direction shown in FIG. 3. Therefore, the filter 480 is provided below the head 30 (see FIGS. 4A to 4C). The fan 94 that sucks the ink mist is provided below the filter 480.

A structure of a positioning portion will be described with reference to FIGS. 7, 8, 10, 11A and 11B. The positioning portion includes a first positioning portion 201, a second positioning portion 202 and the locking plate 496A. As shown in FIGS. 7, 8 and 10, the accommodating portion 49 includes the first positioning portion 201 that positions the filter unit 48 having the built-in filter 480 at an accommodating position P3. As shown in FIGS. 8, 11A and 11B, the accommodating position P3 is a position where the filter unit 48 having the built-in filter 480 is accommodated at the accommodating portion 49 without being displaced. As shown in FIGS. 7, 8 and 10, the first positioning portion 201 is provided above a front end portion of the accommodating portion 49. As shown in FIG. 8, the first positioning portion 201 includes a horizontal plate 201A, a guide inclined surface 201B, a vertical wall 201C and a fixing portion 201D. The horizontal plate 201A is a rectangular plate extending in the left-right direction. The horizontal plate 201A is provided such that a front end portion of the upper surface 484A of the filter unit 48 is not positioned above a bottom surface of the horizontal plate 201A when the filter unit 48 is press-fitted and accommodated in the accommodating portion 49. Even when the filter unit 48 is accommodated without being press-fitted into the accommodating portion 49, the horizontal plate 201A is provided such that the front end portion of the upper surface 484A of the filter unit 48 is not positioned above the bottom surface of the horizontal plate 201A when the front end portion is raised. The first positioning portion 201 is formed of, for example, a metal plate.

The guide inclined surface 201B is a flat surface that is provided at a right end portion of the horizontal plate 201A and is inclined obliquely upward to the right at a predetermined angle with respect to the gravity direction by a predetermined width. The predetermined angle is, for example, 45 degrees. At a replacement position P1 shown in FIG. 6B, the operator removes the used filter 480 together with the filter case 481, fits the filter case 481 having the built-in unused filter 480 into the accommodating portion 49, and then the accommodating portion 49 is closed at a use position P2 shown in FIG. 6A. Closing of the accommodating portion 49 means that the accommodating portion 49 moves from the replacement position P1 shown in FIG. 6B to the use position P2 shown in FIG. 6A. The replacement position P1 is a position where the accommodating portion 49 is positioned on a right side of the inner wall 71, the filter unit 48 accommodated in the accommodating portion 49 can be taken out, and another filter unit can be mounted to the accommodating portion 49. The use position P2 is a position at the time of printing where the accommodating portion 49 is accommodated inside the housing 8. When the accommodating portion 49 is closed, the guide inclined face 201B guides the filter unit 48 to the accommodating position P3 of the accommodating portion 49 (see FIGS. 11A and 11B) while the guide inclined face 201B abuts on the front end portion of the upper face 484A of the filter unit 48. The vertical wall 201C is a rectangular wall extending upward from an upper end of the guide inclined surface 201B. When the filter unit 48 is not correctly accommodated at the accommodating position P3 of the accommodating portion 49 as the accommodating portion 49 is closed, the vertical wall 201C abuts on a side wall 481A of the filter case 481 of the filter unit 48 (see FIGS. 9A and 9B). The fixing portion 201D is provided at a left end portion of the horizontal plate 201A and extends upward by a predetermined width. The fixing portion 201D is fixed to a frame (not shown) inside the printing device 1 by screws.

As shown in FIGS. 6A and 6B, the accommodating portion 49 moves between the replacement position P1 and the use position P2. As shown in FIG. 8, at the use position P2, the first positioning portion 201 is provided at a position separated from the bottom surface 498 of the accommodating position P3 of the filter 480 by a height H1 of the filter 480 or higher as shown in FIG. 5A. FIG. 7 shows a state of the replacement position P1, but the position where the first positioning portion 201 is provided does not change even at the use position P2. As shown in FIGS. 11A and 11B, on an outer side (front side) of the accommodating position P3, the second positioning portion 202 protruding upward from the bottom face 498 of the accommodating position P3 is provided. The second positioning portion 202 is formed by bending a metal plate. The second positioning portion 202 has a guide inclined surface 202A that guides the filter 480 to the accommodating position P3. The guide inclined surface 202A is, for example, a flat surface inclined from above to the rear at a predetermined angle with respect to a horizontal direction. The predetermined angle is, for example, 45 degrees. As shown in FIG. 7, the first positioning portion 201 and the second positioning portion 202 are separated by a distance L1 shorter than the height H1 of the filter unit 48 (filter 480) in a height direction of the filter unit 48 having the built-in filter 480.

When the number of printed sheets in the printing device 1 is equal to a predetermined number, a display for prompting replacement of the filter 480 is displayed on the display screen 16. In the mist collection mechanism 73, when the filter 480 is replaced, the operator operates the engaging portion 493 in a state where the platen 12 is moved to the back of the housing 8. Thereby, engagement with the engaged portion 712 (see FIG. 6B) is released, and the accommodating portion 49 rotates about the hinge 492. The operator grips the filter case 481 from a front surface side of the printing device 1, removes the used filter 480 together with the filter case 481, fits the filter case 481 having the built-in unused filter 480 into the accommodating portion 49, and then operates the engaging portion 493. Thereby, the accommodating portion 49 rotates about the hinge 492, and as shown in FIGS. 5A and 6A, the engaging portion 493 engages with the engaged portion 712, and the main body 491 is accommodated in the inner wall 71.

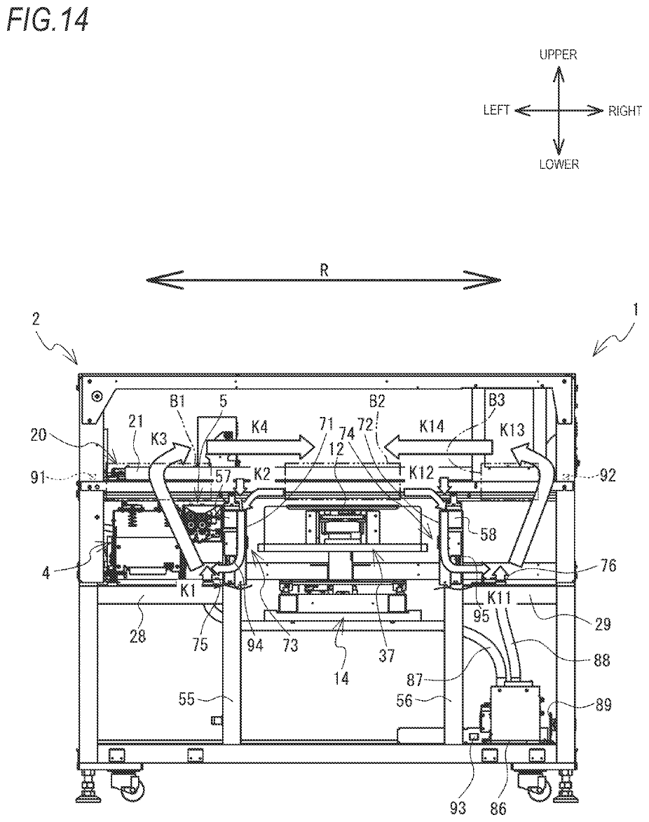

As shown in FIG. 4C, the mist collection mechanism 74 includes the inner wall 72, three fans 95 (only one of which is shown in FIG. 4C) and the filter unit 48, corresponding to the inner wall 71, the three fans 94 and the filter unit 48 of the mist collection mechanism 73, respectively. A slit-shaped suction port 723 elongated in the front-rear direction (see FIG. 12) and corresponding to the suction port 713 is formed in an upper surface of the mist collection mechanism 74. When each fan 95 is driven, the air flows through a space inside the inner wall 72 as indicated by an arrow K12 (see FIG. 14). Specifically, when each fan 95 is driven, the air sucked from the suction port 723 passes through the filter 480 of the filter unit 48, and then is sent from a side of a suction port 955 of the fan 95 to a side of an exhaust port 956 of the fan 95.

The humidifier 86 shown in FIG. 4A supplies humidified air to the supply port 75 arranged on a side of the exhaust port 946 of the fan 94 (a left side of the fan 94). The humidifier 86 supplies the humidified air to the supply port 76 arranged on the side of the exhaust port 956 of the fan 95 (a right side of the fan 95). A position where the humidifier 86 is arranged is not particularly limited, but the humidifier 86 is provided inside the housing 8 and below the partition plate 29. The humidifier 86 includes a storage unit 860 (see FIG. 13), a humidification drive unit 861 (see FIG. 13), a suction port 89, tubes 87, 88, and fans 862, 863 (see FIG. 13). The storage unit 860 stores a liquid (for example, water) used for humidification. A water supply pipe may be connected to the storage unit 860, and, for example, water may be supplied to the storage unit 860 from a water tap or an external device including a water supply tank (not shown).

The suction port 89 is attached to a right side surface of the housing 8, and takes the air into the humidifier 86 from the outside of the housing 8. The humidification drive unit 861 humidifies the air taken into the humidifier 86 from the outside of the housing 8 via the suction port 89 using the liquid stored in the storage unit 860. The humidification drive unit 861 may humidify the air by any method including a steam method, a vaporization method, an ultrasonic method and an electrolysis method. The humidifier 86 may include a filter that removes dust and the like in the air in a flow path of the air before humidification, for example, between the suction port 89 and the storage unit 860 (see FIG. 13). One end of the tube 87 is connected to the humidifier 86, and the other end thereof is connected to the supply port 75. The supply port 75 is located below the head 30 arranged on a left end side of the movement range R. One end of the tube 88 is connected to the humidifier 86, and the other end thereof is connected to the supply port 76. The supply port 76 is located below the head 30 arranged on a right end side of the movement range R.

The fan 862 shown in FIG. 13 supplies the air humidified by the humidification drive unit 861 to the supply port 75 via the tube 87 shown in FIG. 4A. The humidified air supplied to the supply port 75 is sent toward the head 30 through a space (left side space) on the left side of the inner wall 71 inside the housing 8 and above the partition plate 28. The fan 863 shown in FIG. 13 supplies the air humidified by the humidification drive unit 861 to the supply port 76 via the tube 88 shown in FIG. 4A. The humidified air supplied from the supply port 76 is sent toward the head 30 inside the housing 8 through a space (right side space) on the right side of the inner wall 72 inside the housing 8 and above the partition plate 29. In the printing device 1, since an internal space thereof is partitioned into upper and lower spaces by the partition plates 28, 29, the humidified air supplied to the supply ports 75, 76 by the humidifier 86 is easily directed to the head 30.

An electrical configuration of the printing device 1 will be described with reference to FIG. 13. As shown in FIG. 13, a control unit 80 of the printing device 1 includes a CPU 81, a ROM 82 and a RAM 83. The CPU 81 is electrically connected to the ROM 82 and the RAM 83, and controls the printing device 1. The ROM 82 stores a control program for the CPU 81 to control an operation of the printing device 1, information required by the CPU 81 when various programs are executed, and the like. The RAM 83 temporarily stores various types of data used in the control program, print data for printing on the printing medium, and the like. Some of these electrical elements are provided in the substrate box 9 provided on a right side of the head 30.

The main scanning motor 99, the sub-scanning motor 26, a head drive unit 27, a first maintenance drive unit 84, a second maintenance drive unit 85, the humidifier 86, the sensors 91 to 93, 96, the fans 94, 95 and the operation button 15 are electrically connected to the CPU 81. The main scanning motor 99 is driven to move the carriage 6 in the main scanning direction. The sub-scanning motor 26 is driven to move the platen 12 in the sub-scanning direction. Thereby, the head 30 (see FIG. 2A) moves relative to the platen 12 in the main scanning direction and the sub-scanning direction. The head drive unit 27 is configured by a pressure element or the like, and is driven to eject the white ink from the heads 31, 34, eject the discharge printing agent from the heads 32, 35, or eject the color ink from the heads 33, 36.

The first maintenance drive unit 84 can move the cap support portion 47 (see FIG. 2A) in the upper-lower direction. The second maintenance drive unit 85 can change positions of the wipers 601 to 606 (see FIG. 2A) between a contact position and a non-contact position. Each of the sensors 91 to 93 detects a temperature and a humidity inside the housing 8, and outputs a detection result to the CPU 81. The CPU 81 can determine whether the detection result satisfies a predetermined ejection condition based on the detection result from each of the sensors 91 to 93. The operation button 15 is operated by the operator and outputs a signal corresponding to the operation to the CPU 81. The operator can input, for example, a printing instruction for starting printing to the printing device 1 by operating the operation button 15.

As shown in FIG. 4A, each of the sensors 91 to 93 is provided inside the housing 8 and detects both the temperature and the humidity inside the housing 8. The sensors 91, 92 are provided corresponding to the supply ports 75, 76, respectively. For example, as shown in FIGS. 2A and 4A, the sensor 91 is arranged on a left side of the front shaft 21 and in vicinity of an upper side of the supply port 75, and the sensor 92 is arranged on a right side of the front shaft 21 and in vicinity of an upper side of the supply port 76. As shown in FIG. 4A, the sensor 93 is arranged below the partition plate 29 and on a left side of the humidifier 86, and detects a temperature and a humidity of atmosphere around the humidifier 86, that is, non-humidified atmosphere not humidified by the humidifier 86. The sensor 96 is provided in the accommodating portion 49 and detects whether the filter unit 48 is accommodated in the accommodating portion 49.

According to the above configuration, the printing device 1 conveys the printing medium in the front-rear direction and the left-right direction with respect to the head 30 by moving the platen 12 in the front-rear direction (the sub-scanning direction) by driving the sub-scanning motor 26 and moving the carriage 6 in the left-right direction (the main scanning direction) by driving the main scanning motor 99. The printing device 1 ejects various types of liquid from the head 30 while conveying the printing medium in the front-rear direction and the left-right direction with respect to the head 30. Specifically, the printing device 1 first ejects the discharge printing agent from the heads 32, 35 to discharge the color from the printing medium. Alternatively, the printing device 1 first forms a base on the printing medium by ejecting the white ink from the heads 31, 34. The printing device 1 prints a color image by ejecting the color ink from the heads 33, 36 onto a portion of the printing medium from which the color is discharged or the formed base. The printing device 1 may eject both the white ink and the discharge printing agent.

A flow of air inside the housing 8 when the CPU 81 of the printing device 1 drives the fans 94, 95 and the humidifier 86 (see FIG. 1) will be described with reference to FIG. 14. When the CPU 81 drives the fans 94, 95 and the humidifier 86, the humidified air flowing from the humidifier 86 toward the supply port 75, which is indicated by an arrow K1, and the air discharged from the exhaust port 946 of the fan 94 (see FIG. 4B), which is indicated by an arrow K2, merge with each other on the left side of the inner wall 71 inside the housing 8. The humidified air merged with the air discharged from the exhaust port 946 moves leftward and upward in a left side space between the left surface of the housing 8 and the inner wall 71 as indicated by an arrow K3.

The humidified air moves rightward along the upper surface of the housing 8 above the guide shaft 20 as indicated by an arrow K4. Apart of the humidified air is sucked into the inner wall 71 from the suction port 713 (see FIG. 4B), and the rest of the humidified air is discharged to the outside of the housing 8 from the platen opening 13 (see FIG. 1). That is, the humidified air supplied from the supply port 75 merges with the air discharged from the exhaust port 946 of the fan 94 (see FIG. 4B), and moves as indicated by the arrows K3, K4, whereby the nozzle surfaces of the heads 31 to 36 shown in FIG. 2A are humidified, and drying of the liquid inside the nozzle provided in the head 30 is prevented. It is also possible to prevent drying of the foam wiper 611 moistened by the sponge containing the moisturizing liquid arranged inside each of the caps 41 to 46 of the first maintenance mechanism 4 and the cleaning liquid of the second maintenance mechanism 5.

Similarly, in the right side space on the right side of the inner wall 72 inside the housing 8, the air flows indicated by arrows K11 to K13 corresponding to the arrows K1 to K3, respectively. The humidified air moves leftward along the upper surface of the housing 8 above the guide shaft 20 as indicated by an arrow K14. A part of the humidified air is sucked from the suction port 723 (see FIG. 12), and the rest of the humidified air is discharged to the outside of the housing 8 from the platen opening 13. The humidified air supplied from the supply port 76 merges with the air discharged from the exhaust port 956 of the fan 95 (see FIG. 4C), and moves as indicated by the arrows K13, K14, thereby humidifying atmosphere in vicinity of the right end portion of the movement range R of the head 30 and the nozzle surfaces of the heads 31 to 36.

The guide portion 100 guides the waste ink droplets 200 formed of the ink mist to the filter 480, and the filter 480 collects the waste ink droplets 200. Therefore, a possibility that the accommodating portion 49 is contaminated by the waste ink droplets 200 is reduced as compared with the printing device 1 in which the guide portion 100 is not provided. Since the filter 480 collects the waste ink droplets 200, it is possible to reduce contamination not only in the accommodating portion 49 but also in the mist collection mechanism 73.

Since the guide portion 100 has the shape in which the waste ink droplets 200 drop onto the filter 480, the waste ink droplets 200 drop from the guide portion 100 to the filter 480, and the filter 480 collects the waste ink droplets 200. Therefore, a possibility that the accommodating portion 49 is contaminated by the waste ink droplets 200 is reduced.

The guide plate 101 guides the waste ink droplets 200 dropping from the side wall 710 arranged above the accommodating portion 49 to the filter 480. Therefore, the possibility that the accommodating portion 49 is contaminated by the waste ink droplets 200 is reduced.

The guide plate 101 enables the waste ink droplets 200 to drop from the tip end 103 that is the lowermost end to the filter 480 exposed upward at a plurality of positions. Therefore, the filter 480 collects the waste ink droplets 200, and thus the possibility that the accommodating portion 49 is contaminated by the waste ink droplets 200 is reduced.

The nozzle rows 302, 303 that eject a second color liquid different from a first color liquid are provided. A region where the ink mist is generated spreads in the sub-scanning direction that is the arrangement region 304 of the nozzle rows 301 to 303. The filter 480 is arranged such that a longitudinal direction thereof coincides with the sub-scanning direction. Therefore, the filter 480 collects the waste ink droplets 200, and thus the possibility that the accommodating portion 49 is contaminated by the waste ink droplets 200 is reduced.

In the sub-scanning direction, at least a portion of the accommodating portion 49 is arranged in the arrangement region 304 of the nozzle rows 301 to 303, so that the filter 480 can easily collect the waste ink droplets 200 due to the ink mist generated from the nozzle rows 301 to 303. Therefore, the possibility that the accommodating portion 49 is contaminated by the waste ink droplets 200 due to the ink mist is reduced.

The ink mist is sucked by the fans 94, 95, and the filter 480 collects the ink mist. Therefore, a possibility that a portion other than the accommodating portion 49 in the printing device 1 is contaminated can be reduced.

Since the first positioning portion 201 positions the filter 480 at the accommodating position P3 of the accommodating portion 49, a possibility that the filter 480 is displaced from the accommodating position P3 in the accommodating portion 49 is reduced. Therefore, a possibility that the waste ink droplets 200 guided by the guide portion 100 are displaced from the filter 480 is reduced.

The first positioning portion 201 and the second positioning portion 202 are separated by the distance L1 shorter than the height H1 of the filter 480 in the height direction of the filter 480. Therefore, when the filter 480 is arranged while being displaced from the accommodating position P3, as shown in FIG. 11A, a front end portion of the filter 480 is lifted by the second positioning portion 202. Therefore, as shown in FIG. 7, the front end portion of the filter 480 abuts on the vertical wall 201C of the first positioning portion 201. Therefore, the accommodating portion 49 cannot move from the replacement position P1 to the use position P2. Therefore, a possibility that the filter 480 is accommodated in the accommodating portion 49 while being displaced is reduced.

As shown in FIG. 8, since the guide inclined surface 201B guides an upper surface of the front end portion of the filter 480 to the accommodating position P3, the filter 480 can be easily positioned at the accommodating position P3. As shown in FIG. 11B, since the guide inclined surface 202A guides a lower surface of the front end portion of the filter 480 to the accommodating position P3, the filter 480 is easily placed at the accommodating position P3.

The present disclosure can be variously modified from the above embodiment. Various modifications described below may be combined with each other. The filter 480 is not limited to the filter 480 shown in FIG. 9A, which is partitioned into a plurality of portions by the extension portions 487 and is exposed upward at the plurality of positions. As shown in FIG. 9B, the filter 480 may be formed by arranging a plurality of small filters 480A in the front-rear direction. Although four small filters 480A are arranged in FIG. 9B, the number of small filters 480A is not limited to four. A plurality of small filters 480A may be arranged so as to have a length the same as that of the filter 480 shown in FIG. 9A. In this case, the small filters 480A are arranged in the front-rear direction, and the waste ink droplets 200 drop from the tip end 103, which is the lowermost end of each guide plate 101, to the filter 480 exposed upward at the plurality of positions. Therefore, the small filters 480A collect the waste ink droplets 200, and thus a possibility that the accommodating portion 49 is contaminated by the waste ink droplets 200 is reduced.

The guide portion 100 may be, for example, directly above the accommodating portion 49. The guide portion 100 is not necessarily limited to the shape in which the waste ink droplets 200 drop onto the filter 480. In the guide portion 100, for example, the guide plate 101 constituting the guide portion 100 may be in contact with the filter 480. In this case, the guide plate 101 may guide the waste ink droplets 200 to flow to the filter 480. The guide portion 100 does not have to enable the waste ink droplets 200 to drop from the tip end 103 of the guide plate 101. For example, a hole may be formed directly above the filter 480 of the guide plate 101, and the hole may enable the waste ink droplets 200 to drop onto the filter 480. The inclined portion 102 of the guide plate 101 is not limited to the isosceles triangle. For example, the guide plate 101 of the guide portion 100 shown in FIG. 8 may include four inclined portions 102 in the front-rear direction, and each inclined portion 102 may have a trapezoidal shape in a plan view. In this case, two sides that are not parallel extends to become closer as the two sides extend obliquely downward to the left. In this case, a lower side of two parallel sides of a trapezoid is an example of a tip end according to the present disclosure. The filter 480 may have the lowermost end that guides the waste ink droplets 200. For example, the tip end 103 may not be pointed. The tip end 103 may have an arc shape. In this case, since the tip end 103 is not pointed, the filter unit 48 is less likely to be caught by the tip end 103 of the guide plate 101 at the time of attachment and detachment. The guide plate 101 may have, for example, the tip end 103 that is the lowermost end only at one position.

A plurality of tip ends 103 of the guide plate 101 for one exposed filter 480 may be provided, for example. In this case, since the waste ink droplets 200 are guided from the plurality of tip ends 103 to the one exposed filter 480, the waste ink droplets 200 can efficiently drop onto the filter 480. The guide plates 101 may not be integrated with each other in the left-right direction, for example. The inclined portion 102 may be independently fixed to the side wall 710, for example. The inclined portions 102 do not necessarily have to have the same shape, for example. In these cases, the inclined portion 102 can be provided corresponding to a position and a size of each of the exposed filters 480. The tip end 103 of each guide plate 101 does not necessarily have to face the center of the opening 485A of the filter case 481 in the front-rear direction, for example. The tip end 103 of each guide plate 101 may face somewhere in a range of the opening 485A of the filter case 481, for example. Each guide plate 101 may have a shape in which the tip end is a lowermost end at at least one of the plurality of the openings 485A. The inclination angle of the guide plate 101 is not limited to 45 degrees. It may be inclined toward the opening 485A of the filter case 481.

In addition to the first nozzle row and the second nozzle row, for example, a third nozzle row that ejects ink of a color different from those of the first nozzle row and the second nozzle row may be provided. In this case, at least a portion of the accommodating portion 49 may be arranged in an arrangement region of the first nozzle row to the third nozzle row. In this case, even when the first nozzle row to the third nozzle row are arranged, a possibility that the accommodating portion is contaminated by the waste ink droplets due to the ink mist is reduced. For example, the first positioning portion 201 may not be provided corresponding to the front end portion of the accommodating portion 49. The first positioning portion 201 may be provided between the front end portion and a central portion of the accommodating portion 49 in the front-rear direction. The first positioning portion 201, the second positioning portion 202 and the locking plate 496A are not limited to metal plates, and may be members made of resin, for example.

The accommodating portion 49, the filter unit 48 and the filter 480 are arranged such that longitudinal directions thereof coincide with the front-rear direction of the printing device 1, but may be arranged so as to coincide with the left-right direction of the printing device 1, for example. The accommodating portion 49 is not limited to the above-described position, and may be provided, for example, on a right side or a left side of the platen opening 13 on a front surface of the main body 10. In this case, the accommodating portion 49 may be provided so as to be drawn out from the inside of the printing device 1, and the filter 480 may be attached or detached from the front surface side, or the filter 480 may be attached or detached from the front surface side by removing the front panel.

The main scanning direction, the sub-scanning direction and the ejection direction of the printing device 1 may be appropriately changed to any direction of the printing device 1 depending on a configuration of the printing device 1. The shapes, numbers and arrangement of the fans 94, 95, the supply ports 75, 76 and the filter 480 may be changed as appropriate. At least one of the inner walls 71, 72 may be omitted, or the configuration and arrangement may be appropriately changed. For example, the printing device 1 may include one or more fans inside the housing 8, and any one of the fans 94, 95 may be omitted. Although three fans 94 are arranged in the front-rear direction, the number of fans 94 may be four or more, or may be two or less. The number of fans 94 and the number of fans 95 may be the same or different from each other. A fan may be provided only on one of the inner walls 71, 72. At least one of the fans 94, 95 may be provided in a portion other than the inner walls 71, 72 (for example, in the left side space or the right space). The supply port 75 may be provided between the fan 94 and the head 30.

The inclination angle of the guide inclined surfaces 201B, 202A is not limited to 45 degrees. The angle may be set to an angle suitable for guiding. The guide inclined surfaces 201B, 202A are not limited to the flat surfaces, and may be curved surfaces, for example. The filter 480 may not include the filter case 481.

What is claimed is:

1. A printing device comprising:
an inkjet head;
an accommodating portion configured to accommodate a filter that collects ink mist; and
a guide portion arranged above the accommodating portion and configured to guide waste ink droplets due to the ink mist to the filter accommodated in the accommodating portion.

2. The printing device according to claim 1,
wherein the guide portion has a shape in which the waste ink droplets drop onto the filter.

3. The printing device according to claim 1,
wherein the guide portion includes a guide plate extending toward a lateral side of the guide portion from a side wall arranged above the accommodating portion, and
wherein the filter accommodated in the accommodating portion is disposed at a position lowered in a gravity direction from a tip end of the guide plate in the lateral side.

4. The printing device according to claim 3,
wherein the filter is exposed upward at a plurality of exposing positions which is made by arranging a plurality of filter members, or by using a partition, and
wherein the guide plate has a shape in which the tip end is a lowermost end at at least one of the exposing positions.

5. The printing device according to claim 1, further comprising:
a first nozzle row for a first color; and
a second nozzle row for a second color,
wherein the filter extends in a sub-scanning direction of the printing device, and
wherein a longitudinal direction of the filter coincides with the sub-canning direction.

6. The printing device according to claim 5,
wherein the second nozzle row is disposed in the sub-scanning direction with respect to the first nozzle row, and
wherein at least a portion of the accommodating portion is disposed between a first arrangement region of the first nozzle row and a second arrangement region of the second nozzle row in the sub-scanning direction.

7. The printing device according to claim 1,
wherein the filter is provided below the inkjet head, and
wherein a fan that is configured to suck the ink mist is provided below the filter.

8. The printing device according to claim 1,
wherein the accommodating portion includes a positioning portion that positions the filter at an accommodating position in the accommodation portion.

9. The printing device according to claim 8,
wherein the accommodating portion is movable between a replacement position and a use position, and
wherein the positioning portion includes:
a first positioning portion provided at a position separated from a bottom surface of the accommodating position of the filter by a height of the filter or higher at the use position, and
a second positioning portion protruding from the bottom surface of the accommodating position on an outer side of the accommodating position,
wherein the first positioning portion and the second positioning portion are separated by a distance shorter than the height of the filter in a height direction of the filter.

10. The printing device according to claim 8, wherein the positioning portion has a guide inclined surface that is configured to guide the filter to the accommodating position.

11. The printing device according to claim 5, wherein the first color is white and the second color is one of cyan, magenta, yellow, or black.

12. The printing device according to claim 1, further comprising:
a first nozzle row for a first color; and
a second nozzle row for a second color,
wherein the filter includes a plurality of small filters arranged in a sub-scanning direction of the printing device.

13. The printing device according to claim 12,
wherein the second nozzle row is disposed in the sub-scanning direction with respect to the first nozzle row, and
wherein at least a portion of the accommodating portion is disposed between a first arrangement region of the first nozzle row and a second arrangement region of the second nozzle row in the sub-scanning direction.

14. The printing device according to claim 12, wherein the first color is white and the second color is one of cyan, magenta, yellow, or black.
